(19) United States
(12) Patent Application Publication
(10) Pub. No.: US 2005/0251514 A1
(43) Pub. Date: Nov. 10, 2005

(54) Evaluation and cluster formation based on element correlation

(75) Inventor: Michael Edward Houle, Kawasaki-shi (JP)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 11/104,936

(22) Filed: Apr. 13, 2005

(30) Foreign Application Priority Data
Apr. 14, 2004 (JP) 2004-118758

(51) Int. Cl. G06F 17/30

(52) U.S. Cl. 707/3

(57) ABSTRACT

System for calculating a self-confidence value in selection of a cluster including: evaluation unit selecting a neighbor element set as a target cluster for evaluation, the neighbor element set being a set of a reference number of elements each having a higher correlation with a reference element; a neighbor unit selecting a neighbor element set for each of member elements included in the cluster, the neighbor element set being a set of reference number of elements having a higher correlation with the relevant member element; and a confidence unit which calculating, for a combination of two member elements available from the cluster, the number of elements included both in the neighbor element set for one member element of the combination and in the neighbor element set for the other member element, and outputting an average of ratios calculated for all the combinations of member elements, as the self-confidence value.

### FIELD OF THE INVENTION

The present invention relates to an evaluation system, a cluster formation device, a program, a recording medium, an evaluation method, and a cluster formation method. The present invention particularly relates to an evaluation system, a cluster formation device, a program, a recording medium, an evaluation method, and a cluster formation method, by which a cluster is formed from a plurality of elements having a predetermined degree of correlation with each other.

### BACKGROUND OF THE INVENTION

In recent years, as a computer has been developed and widespread, a variety of data has come to be digitized. The digitized data is utilized in various industries. For example, it has been proposed to do a marketing research based on data in which purchasing actions for commercial articles are digitized, to estimate variations of stock prices based on data in which economic indicators and the like are digitized. However, when such digitized data is enormous, it is difficult to appropriately select only effective data. Accordingly, a technology such as data mining has heretofore received attention. As a technology which becomes the foundation of the data mining, the inventor of this application has proposed a method, for a cluster formed by selecting the reference number of member elements from a plurality of elements constituting a database, for evaluating a degree of confidence in selection of the member elements (refer to Non-Patent Document 2). This technology evaluates, for a predetermined reference element in the cluster, an average value of correlation strengths between the reference element and the other respective member elements as a degree of confidence.

Moreover, the inventor of this application has proposed a technology for determining the cluster by use of the degree of confidence. According to this technology, first, a set of the reference number of elements of which correlations with a certain reference element are higher is selected as a candidate for the cluster. Next, for each of a plurality of the candidates for the clusters obtained by varying the reference number, a difference of the degree of confidence between the candidate for the cluster and a set including more member elements than the candidate for the cluster is calculated. Then, a candidate for the cluster, in which the calculated difference becomes maximum, is determined as the cluster to be formed.

The following documents are considered:
[Non-Patent Document 1] S. Brin, R. Motwani and C. Silverstein, Beyond market baskets: generalizing association rules to correlations, Proc. ACM SIGMOD International Conference on Management of Date, Tucson, U.S.A., 1997 pp. 265-276.
[Non-Patent Document 2] Michael E. Houle, Navigating massive data sets via local clustering, Proc. ACM SIGKDD International Conference on Knowledge Discovery and Data Mining, Washington, U.S.A., 2003, pp. 547-552.
[Non-Patent Document 3] G. V. Kass, An exploratory technique for investigating large quantities of categorical data, J. Applied Statistics 29: 119-129, 1980.

[Non-Patent Document 4] E. S. Keeping, Introduction to Statistical Inference, Dover Publications, New York, USA, 1995.

[Non-Patent Document 5] Gerald Salton, The SMART Retrieval System—Experiments in Automatic Document Processing, Prentice-Hall, Englewood Cliffs, N.J., USA, 1971.

Note that, as a related art, a technology for applying a chi-square test value to the data mining has been proposed (refer to Non-Patent Documents 1 and 3). Non-Patent Documents 4 and 5 are described later.

However, in the evaluation of the cluster, even in the case where the correlations of the certain reference element with the other respective member elements are high, when the other respective member elements do not strongly correlate with each other, it cannot be said that the respective member elements in the cluster strongly correlate with each other. For example, description is made by taking, as an example, the case where a certain database includes, as such a reference element, a sentence “the research institute is developing a video transmission control technology for cellular phones.”

When this database has, as another element, a sentence which relates to the “video transmission control technology” and has no relationship with the “cellular phone,” both of this element and the reference element include the keyword “video transmission control technology. ” Accordingly, it is conceived that both of the elements are similar to each other and strongly correlate with each other. In a similar way, when this database has, as still another element, a sentence which relates to the “cellular phone” and has no relationship with the “video transmission control technology,” it is conceived that both of this element and the reference element are similar to each other and strongly correlate with each other because both of the elements include the keyword “cellular phone.”

However, the sentence which relates to the “video transmission control technology” and has no relationship with the “cellular phone,” and the sentence which relates to the “cellular phone” and has no relationship with the “video transmission control technology” do not have a keyword common thereto or are not similar to each other. According to the technology described in the foregoing Non-Patent Document 2, there has been a case where such a plurality of elements which have no relationship with each other are included in the same cluster.

Moreover, in the determination of the cluster, there is a case where the degree of confidence is gradually varied and a point which is radically varied is not detected even if the reference number is sequentially varied. In such a case, it is not appropriate to determine, as the cluster, a set of elements having a certain degree of confidence based on evidence that a certain difference of the degree of confidence is slightly larger than differences of the other degrees of confidence. Furthermore, it is necessary to calculate such a degree of confidence for a set of elements with a predetermined number larger than the reference number, every time when the reference number is varied, thus resulting in an increase of a calculation amount.

Moreover, according to the conventional data mining, though approximately 25 member elements can be selected for the cluster, approximately two member elements which correlate with each other very strongly cannot be selected for the cluster. There are many cases where even such a relatively small cluster includes useful information. In addition, there are many cases where a user can easily select the approximately 25 member elements as the cluster based on experience and knowledge thereof without using the data mining. Meanwhile, in many cases, it is difficult to discover the cluster including the approximately two elements. Hence, it is a subject to select such a cluster which is difficult to discover and useful.

### SUMMARY OF THE INVENTION

Therefore, it is an object of the present invention to provide an evaluation system, a cluster formation device, a program, a recording medium, an evaluation method, and a cluster formation method, which are capable of solving the problem described above. This object is achieved by a combination of features described in independent claims in the scope of claims. Moreover, dependent claims define more advantageous concrete examples of the present invention.

In order to achieve the object, in a first aspect of the present invention, provided are: an evaluation system to be described below; a cluster formation device, an evaluation method and a cluster formation method, which use the evaluation system; a program for causing a computer to function as the evaluation system or the cluster formation device; and a recording medium recording the program. The evaluation system is one for calculating a self-confidence value for a cluster formed by selecting some of a plurality of elements having a predetermined degree of correlation with each other, the self-confidence value indicating a degree of confidence in selection of member elements included in the cluster, the evaluation system including: an evaluation target cluster selection unit which, for a predetermined reference element, selects a neighbor element set as a target cluster for evaluation, the neighbor element set being a set of a reference number of elements each having a higher correlation with the reference element; a neighbor element set selection unit which selects a neighbor element set for each of member elements included in the cluster, the neighbor element set being a set of the reference number of elements each having a higher correlation with the relevant member element; and a confidence value calculation unit which, for a combination of two member elements available from the cluster, calculates a ratio of the number of elements to the reference number, the elements being included both in the neighbor element set for one member element of the combination and in the neighbor element set for the other member element, and which outputs, as the self-confidence value, a value based on a sum of the ratios calculated for all the combinations of the member elements.

In a second aspect of the present invention, provided are: an evaluation system to be described below; a cluster formation device, an evaluation method and a cluster formation method, which use the evaluation system; a program for causing a computer to function as the evaluation system or the cluster formation device; and a recording medium recording the program.

In a third aspect of the present invention, provided are: a cluster formation device to be described below; a cluster formation method; a program for causing a computer to function as the cluster formation device; and a recording medium recording the program.

According to the present invention, it is possible to select, for a cluster, member elements having high correlations with each other among a plurality of elements stored in a database or the like.

### BRIEF DESCRIPTION OF THE DRAWINGS

For a more complete understanding of the present invention and the advantages thereof, reference is now made to the following description taken in conjunction with the accompanying drawings.

FIG. 1 is a functional block diagram of a document database 10 and a cluster formation device 20 (in Embodiment 1).

FIG. 2 shows a flow of processing where the cluster formation device 20 selects member elements and forms a cluster (in Embodiment 1).

FIG. 3 is a diagram for explaining details of processing in S230 (in Embodiment 1).

FIG. 4 is a functional block diagram of a document database 10 and a cluster formation device 20 (in Embodiment 2).

FIG. 5 shows a flow of processing where the cluster formation device 20 selects the member elements and forms a cluster (in Embodiment 2).

FIG. 6 shows an example of a hardware configuration of a computer 500 which functions as the cluster formation device 20 (in Embodiments 1 and 2).

### DETAILED DESCRIPTION OF THE PREFERRED EMBODIMENTS

The present invention provides an evaluation system, a cluster formation device, a program, a recording medium, an evaluation method, and a cluster formation method, which are capable of solving the problem described above. This is achieved by a combination of features described in independent items. Moreover, dependent items define more advantageous concrete examples of the present invention.

In the present invention, there are provided: an evaluation system to be described below; a cluster formation device, an evaluation method and a cluster formation method, which use the evaluation system; a program for causing a computer to function as the evaluation system or the cluster formation device; and a recording medium recording the program. The evaluation system is one for calculating a self-confidence value for a cluster formed by selecting some of a plurality of elements having a predetermined degree of correlation with each other, the self-confidence value indicating a degree of confidence in selection of member elements included in the cluster, the evaluation system including: an evaluation target cluster selection unit which, for a predetermined reference element, selects a neighbor element set as a target cluster for evaluation, the neighbor element set being a set of a reference number of elements each having a higher correlation with the reference element; a neighbor element set selection unit which selects a neighbor element set for each of member elements included in the cluster, the neighbor element set being a set of the reference number of elements each having a higher correlation with the relevant member element; and a confidence value calculation unit which, for a combination of two member elements available from the cluster, calculates a ratio of the number of elements to the reference number, the elements being included both in the neighbor element set for one member element of the combination and in the neighbor element set for the other member element, and which outputs, as the self-confidence value, a value based on a sum of the ratios calculated for all the combinations of the member elements.

In a second aspect of the present invention, provided are: an evaluation system to be described below; a cluster formation device, an evaluation method and a cluster formation method, which use the evaluation system; a program for causing a computer to function as the evaluation system or the cluster formation device; and a recording medium recording the program. The evaluation system is one for calculating an evaluation value of particularity of a cluster in comparison with all of a plurality of elements, for the cluster formed by selecting a predetermined reference number of elements among the plurality of elements having a predetermined degree of correlation with each other, the evaluation system including: an evaluation target cluster selection unit which selects a neighbor element set as a target cluster for evaluation, the neighbor element set being a set of the reference number of elements each having a higher correlation with a predetermined reference element; a neighbor element set selection unit which selects a neighbor element set for each of member elements included in the cluster, the neighbor element set being a set of the reference number of elements each having a higher correlation with the relevant member element; a confidence value calculation unit which, based on the neighbor element set selected by the neighbor element set selection unit, calculates a self-confidence value indicating a degree of confidence in selection of member elements included in the cluster; a theoretical value calculation unit which calculates a theoretical value of a self-confidence value to be calculated by the confidence value calculation unit when it is assumed that the neighbor element set selection unit randomly selects a set of the reference number of elements among the plurality of elements, instead of the neighbor element set; and an evaluation value calculation unit which calculates and outputs, as the evaluation value, a chi-square test value of a self-confidence value for the theoretical value of the self-confidence value.

In the present invention, also provided are: a cluster formation device to be described below; a cluster formation method; a program for causing a computer to function as the cluster formation device; and a recording medium recording the program. The cluster formation device is one for forming a cluster from a plurality of elements each having at least one of a plurality of attributes, the cluster formation device including: an element set selection unit which selects a set of elements having an attribute in question, for each of the plurality of attributes; a correlation degree calculation unit which calculates a correlation degree, indicating a degree of correlation of each of the plurality of attributes with each of the other attributes, based on the number of elements having both an attribute in question and another attribute in question; an attribute cluster formation unit which forms an attribute cluster having a plurality of attributes between which the correlation degree is equal to or more than a reference, based on the calculated correlation degree; and an element cluster formation unit which determines a set of elements having at least one of the attributes included in the attribute cluster and which outputs the determined set of elements as the cluster. Note that subcombinations of groups of these features are also be incorporated in the invention. Thus, according to the present invention, it is possible to select, for a cluster, member elements having high correlations with each other among a plurality of elements stored in a database or the like.

The present invention is further described below through particular embodiments. However, the embodiments below do not limit the invention, even though not all combinations of features described in the embodiments are essential to the problem solving means of the invention.

### Embodiment 1

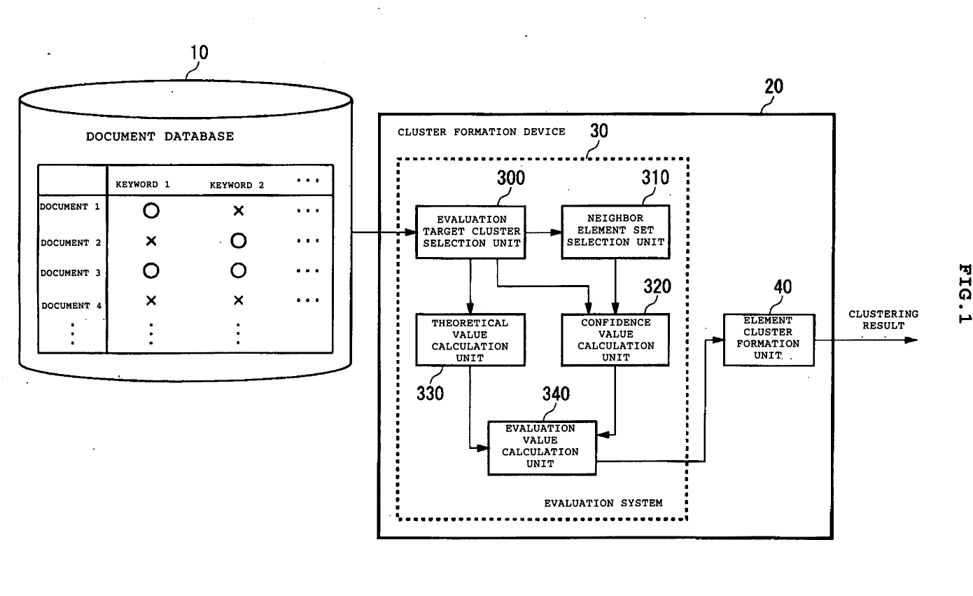

FIG. 1 is a functional block diagram of a document database 10 and a cluster formation device 20 (in Embodiment 1). An object of the cluster formation device 20 is to calculate, for a candidate for a cluster formed by selecting some of a plurality of elements having a predetermined degree of correlation with each other in the document database 10, a confidence value which is a degree of confidence in selection of member elements included in the candidate of the cluster. Another object of the cluster formation device 20 is to determine an appropriate cluster to be formed, based on the confidence value calculated for each candidate for the cluster.

The document database 10 stores a plurality of documents as the plurality of elements having the predetermined degree of correlation with each other. Each of the plurality of documents has any of a plurality of predetermined attributes, for example, any of a plurality of keywords. As an example, a document 1 includes a keyword 1, and does not include a keyword 2. More specifically, in the example of this diagram, a set of the attributes of the respective elements is represented as a vector in which values of the attributes are arrayed. The values of the attributes are binary values indicating whether or not the document has the keyword. A model of data having such a binary attribute vector is referred to as a Boolean model.

In place of this, the value of each attribute may be a continuous value having a magnitude. For example, in an example of a document, each attribute may have a value based on the number of times a keyword corresponding to the attribute is used in the document, a frequency with which the keyword is used therein, and an appearance place of the keyword. More specifically, in the case where a keyword of a certain attribute is used in a title of a chapter or section of the document, the attribute may have a value higher than that in the case where the keyword is used in other places. A formation method of such an attribute vector has been heretofore known as a TF-IDF technology in public, and more detailed description is omitted.

The degree of correlation in which the plurality of documents correlate with each other is predetermined based on a set of the keywords commonly included in the plurality of documents. For example, in the case where the number of keywords commonly included in both of two certain documents is larger, the two documents correlate with each other more strongly in comparison with the case where the number of keywords is smaller. More specifically, the degree of correlation of two certain documents may also be determined based on a distance between coordinates represented by a vector in which values of attributes in one document are arrayed and coordinates represented by a vector in which values of attributes in the other document are arrayed. However, the distance in this case includes one which does not satisfy a triangle inequity.

As still another example, the degree of correlation of two certain documents may also be determined based on an angle between the attribute vectors of the respective documents. In this case, the degree of correlation is higher when the angle is smaller, and the degree of correlation is lower when the angle is larger. A formation method of the degree of correlation based on the angle is demonstrated in Non-Patent Document 5, and accordingly, description thereof in the embodiment is omitted.

As another example, the document database 10 may have a plurality of multimedia data as the plurality of elements having the predetermined degree of correlation with each other. The multimedia data is, for example, a motion picture, a still image, an audio, a video, or the like. In this case, the attribute may indicate whether or not the data includes a predetermined video or audio. In this case, also, a model of the data is not limited to the Boolean model, and the attribute may take a value having a magnitude. The degree of correlation in this example is a value indicating similarity of the multimedia data.

The cluster formation device 20 includes an evaluation system 30, and an element cluster formation unit 40. The evaluation system 30 includes an evaluation target cluster selection unit 300, a neighbor element set selection unit 310, a confidence value calculation unit 320, a theoretical value calculation unit 330, and an evaluation value calculation unit 340. The evaluation target cluster selection unit 300 takes a predetermined document as a reference element, and selects, as a target cluster for evaluation, a neighbor element set which is a set of the reference number of elements each having a higher correlation with the reference element. For example, the evaluation target cluster selection unit 300 selects, as the neighbor element set, a set of the reference number of documents in which sets of the included keywords are more similar to that of the predetermined document.

The neighbor element set selection unit 310 selects, for each of member elements included in the cluster, a neighbor element set which is a set of the reference number of elements each having a higher correlation with the relevant member element. For example, the neighbor element set selection unit 310 selects, for each document included in the cluster, a set of the reference number of documents in which sets of the included keywords are more similar to that of the relevant document, as a neighbor element set of the relevant document.

The confidence value calculation unit 320 calculates a self-confidence value indicating a degree of confidence in selection of member elements included in the target cluster for evaluation, based on the neighbor element set selected by the neighbor element set selection unit 310. Specifically, first, the confidence value calculation unit 320 calculates, for all combinations of two member elements (for example, documents) available from the target cluster for evaluation, the number of elements commonly included both in the neighbor element set for one member element of each combination and in the neighbor element set for the other member element thereof.

Next, the confidence value calculation unit 320 calculates a ratio of the number of elements to the reference number. Then, the confidence value calculation unit 320 calculates a value based on a sum of the ratios for all the combinations of the member elements, for example, an average value of the ratios, as the self-confidence value, and outputs the calculated self-confidence value to the evaluation value calculation unit 340. Subsequently, the theoretical value calculation unit 330 calculates a theoretical value of a self-confidence value to be calculated by the confidence value calculation unit 320 when it is assumed that the neighbor element selection unit 310 randomly selects a set of the reference number of elements among all the elements stored in the document database 10, instead of the neighbor element set.

The evaluation value calculation unit 340 calculates an evaluation value of particularity of the target cluster for evaluation for all the plurality of elements in the document database 10. Specifically, the evaluation value calculation unit 340 calculates, as the evaluation value, a chi-square test value of the self-confidence value calculated by the confidence value calculation unit 320 for the theoretical value of the self-confidence value, which is calculated by the theoretical value calculation unit 330, and outputs the calculated evaluation value to the element cluster formation unit 40.

The element cluster formation unit 40 allows the evaluation value calculation unit 340 to calculate the evaluation value for each of a plurality of clusters obtained by varying the reference number within a predetermined range, and selects a cluster which maximizes the calculated evaluation value. Then, the element cluster formation unit 40 outputs the selected cluster as a clustering result to a user. In place of this, the element cluster formation unit 40 may determine, for each cluster obtained by varying the reference number, that the target cluster for evaluation is a cluster to be formed when the evaluation value of the cluster or the self-confidence value thereof is larger than a predetermined reference value.

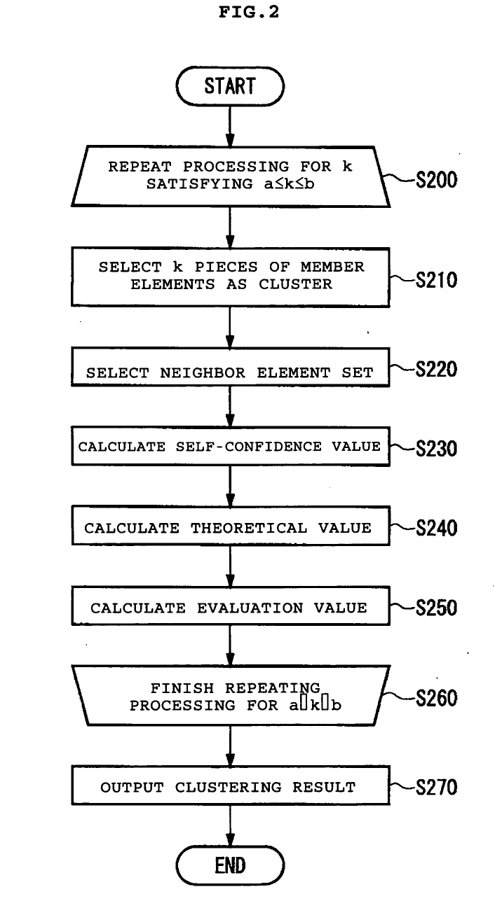

FIG. 2 shows a flow of processing where the cluster formation device 20 selects the member elements and forms the cluster (in Embodiment 1). The evaluation system 30 repeats the following processing for each of reference numbers k varied within a predetermined range which is equal to or more than a and equal to or less than b (S200). First, the evaluation target cluster selection unit 300 selects a neighbor element set which is a set of k pieces of the elements each having a higher correlation with a predetermined reference element, as the member elements in the target cluster for evaluation (S210).

Here, for a domain D which is a set of certain elements, a set of elements in the domain D, which are to be stored in the document database 10, is defined as S. A set of elements in the set S, which becomes the target for evaluation in this embodiment, is defined as R. The predetermined reference element is defined as: q ε D. Then, the target cluster for evaluation is defined as: NN(R, q, k). Specifically, the target cluster for evaluation is a set of first to k-th elements in the set R, which strongly correlate with the reference element q.

In this case, NN(R, q, k) is uniquely determined for the reference element q. Moreover, NN(R, q, k) satisfies the following properties.
If qεD, NN(R, q, 1)={q}
For every k satisfying 1<k≦|R|, NN(R, q, k−1)⊂NN(R, q, k)

Furthermore, for certain qᵢ and kᵢ, NN(R, qᵢ, kᵢ) is represented as Cᵢ. In a similar way, for certain qⱼ and kⱼ, NN(R, qⱼ, kⱼ) is represented as Cⱼ.

Subsequently, the neighbor element set selection unit 310 selects, for each of the member elements included in the target cluster for evaluation, the neighbor element set which is the set of the k pieces of the elements which strongly correlate with the relevant member element (S220). Next, the confidence value calculation unit 320 calculates the self-confidence value (S230).

The self-confidence value is a value based on the strength in which the plurality of elements in the cluster correlate with each other. Accordingly, when the self-confidence value is simply calculated, a calculation amount in proportion to the cube of the number of elements in the cluster is required. As opposed to this, a calculation method for calculating the self-confidence value based on a calculation amount in proportion to the square of the number of elements in the cluster is described.

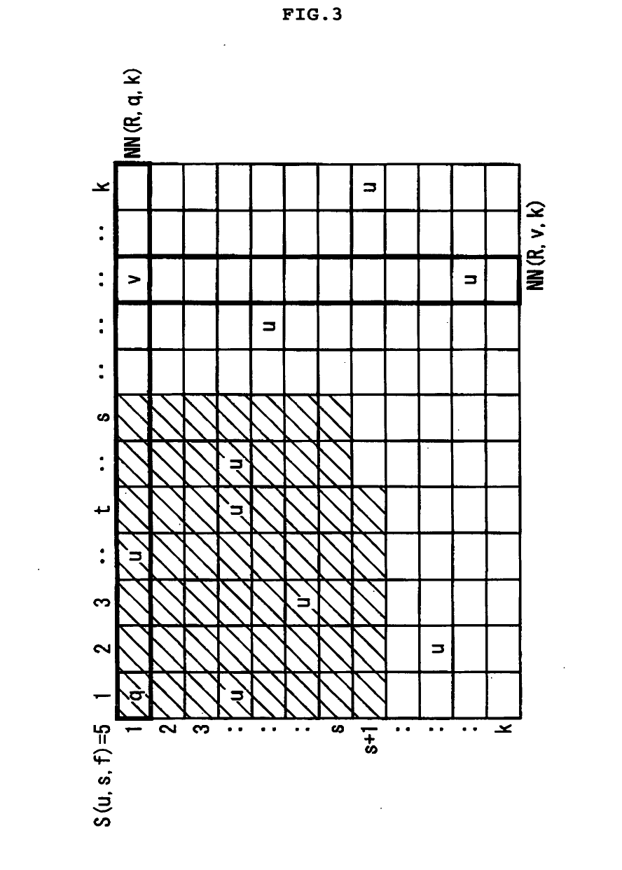

FIG. 3 is a diagram for explaining details of the processing in S230 (in Embodiment 1). First, the self-confidence value to be calculated by the confidence value calculation unit 320 is represented by Expression (1). This confidence value is referred to below as AASCONF.

$$[ Expression 1 ]$$

$$AASCONF ( {C}_{q} ) = {\sum }_{v , w ∈ NN ( R , q , k ) , v \neq w} \vert NN ( R , v , k ) ⋂ NN ( R , w , k ) \vert \text{)} / [ {k}^{*} ( k - 1 ) / 2 ] \qquad ( 1 )$$

According to this expression, the total number of all the combinations of two member elements available from the cluster is the square of the number of elements in the cluster. Moreover, it is conceived that a calculation amount in proportion to the number of elements in the cluster is required in order to count the elements commonly included in the respective combinations. Hence, the calculation amount is proportional to the cube of the number of member elements. When the calculation amount is large as described above, not only efficiency of the calculation is low, but also scalability thereof to a database of which data size is large is low.

As opposed to this, in this embodiment, the self-confidence value is calculated by a method described below. First, ρ(u, t) is defined as a t-th element counted from an element which has the highest correlation with a certain element u. Specifically, ρ satisfies the following Expression (2).

[Expression 2]
ρ(u,t)εNN(R,u,t),ρ(u,t)∉NN(R,u,t−1) (2)

Next, δ(u, s, t) is defined as a parameter taking 1 when an s-th element counted from an element which has the highest correlation with the certain reference element q is defined as a relay element, and when a t-th element counted from an element which has the highest correlation with the relay element is a certain element u, or otherwise taking 0. Next, S(u, s, t) is defined as the sum of the following value 1 and value 2. First, the value 1 is the number of elements available as the relay element when any of the s pieces of elements having high correlations with the reference element q is defined as the relay element, and when any of the s pieces of elements having high correlations with the relay element is the element u. The value 2 is a value taking 1 when an s+1 st element counted from an element which has the highest correlation with the reference element q is defined as the relay element, and when any of the t pieces of elements having high correlations with the relay element is u, or otherwise taking the value of 0 when any of the t pieces of elements is not u. Specifically, S(u, s, t) is defined by the following Expression (3).

$$[ Expression 3 ]$$

$$S ( u , s , t ) = {\sum }_{i = 1}^{s} {\sum }_{j = 1}^{s} δ ( u , i , j ) + {\sum }_{j = 1}^{t} δ ( u , s + 1 , j ) \qquad ( 3 )$$

This diagram shows the relay elements for the certain element u. An axis of abscissas of this diagram shows relationships between the element q and the relay elements. An axis of ordinates of this diagram shows relationships between the relay elements and the element u. According to this example, the confidence value calculation unit 320 calculates the appearance number of element u as 5 at a stage where the calculation has been performed over a hatched portion.

Next, T(u, S, t) is defined, for the certain element u, as the total number of combinations in which two relay elements are selected among all the relay elements reachable to the element u. Specifically, T (u, s, t) is defined as: T(u, s, t)=S(u, s, t)*[S(u, s, t)−1]/2. Based on the above-described definitions, the self-confidence value is represented as the following Expression (4).

$$[ Expression 4 ]$$

$$AASCONF ( {C}_{q} ) = \text{[} {\sum }_{u ∈ R} T ( u , \vert {C}_{q} \vert , 0 ] / [ {\vert {C}_{q} \vert}^{2} * ( \vert {C}_{q} \vert - 1 ) / 2 ] \qquad ( 4 )$$

Here, for uεR, S and T satisfy the following respective properties.
S(u, 1, 0)=1 if u=q, and S(u, 1, 0)=0 if u≠q.
For all s>1,
   S(u, s, 0)=S(u, s ?1, s ?1)+1 if uεNN(R, u, s), and
   S(u, s, 0)=S(u, s ?1, s−1) if not (uεNN(R, u, s)).
For all s>1 and 0<t≦s, S(u, s, t)=S(u, s, t−1)+?(u, s+1, t).
T(u, 1, 0)=0 for all u.
For all s>1,
   T(u, s, 0)=T(u, s?1, s−1)+S(u, s?1, s−1) if u ε NN(R, u, s),
   and
   T(u, s, 0)=T(u, s?1, s−1) if not (u ε NN(R, u, s)).
For all s>1 and 0<t≦s,
   T(u, s, t)=T(u, s, t−1)+S(u, s, t−1) if ?(u, s+1, t)=1, and
   T(u, s, t)=T(u, s, t−1) if ?(u, s+1, t)=0.

Thus, the self-confidence value is calculated by an algorithm shown in the following Expression (5). Here, at the time when processing by this algorithm is finished, S(u) stores S(u, s, t), and TT stores Σ_{uεR}T(u, s, t).

[Expression 5]
step1.S(q) is set at 1, T is set at 0, and for all u which is not q, S(u) is set at 0.
step2.repeat processing from s=2 to k
   for all t from step2-i.t=1 to s−1 add S(ρ(ρ(q,t),s)) to TT, and increment S(ρ(ρ(q,t),s))
   for all u included in step2-ii.NN(R,ρ(q,s),s), add S(u) to TT, and increment S(u)
      step3.output TT/[k²(k−1)/2] (5)

According to this algorithm, for the certain reference element q, the confidence value calculation unit 320 defines any of the k pieces of elements having the higher correlations with the reference element as the relay element, and can calculate, for each of the k pieces of elements having the higher correlations with the relay element, the number of all the relay elements available as S(u), in order to reach the relevant element. Moreover, the confidence value calculation unit 320 can calculate the total number of combinations of two relay elements among all the relay elements available in order to reach each element u satisfying uεR to TT. Furthermore, by step 3, the confidence value calculation unit 320 can calculate, for each combination of the member elements, a ratio, to the reference number, of the number of elements commonly included in the neighbor element sets for one member element and the other member element.

Note that, at the time when step2-ii is finished, the confidence value calculation unit 320 can calculate, as S(u), the total number of relay elements when the reference number is s. Moreover, at this point of time, the confidence value calculation unit 320 divides TT by k²(k−1)/2, and thus can calculate the self-confidence value for the case where the reference number is s. Hence, it is desirable that the confidence value calculation unit 320 process the above-described step 2-i and step 2-ii for each processing repeated from S200 to s260.

In place of the above-described processing, the confidence value calculation unit 320 may calculate, for each of the plurality of member elements in the target cluster for evaluation, a ratio of elements included in the member element among the elements included in the cluster, and may calculate, as the self-confidence value, a value based on the sum of the ratios each of which is calculated for each of the member elements. This confidence value is referred to as A1SCONF. Specifically, A1SCONF is defined by the following Expression (6).

$$[ Expression 6 ]$$

$$A 1 SCONF ( {C}_{q} ) = ( 1 / {K}^{2} ) * {\sum }_{V ∈ {C}_{q}} \vert NN ( R , q , k ) ⋂ NN ( R , v , k ) \vert \qquad ( 6 )$$

Description returns to FIG. 2. Subsequently, the theoretical value calculation unit 330 calculates a theoretical value of the self-confidence value to be calculated by the confidence value calculation unit 320 in the case where it is assumed that the neighbor element set selection unit 310 has randomly selected a set of the reference number of elements from all the elements stored in the document database 10, instead of the neighbor element set (S240). Then, the evaluation value calculation unit 340 calculates, as an evaluation value, a chi-square test value of the self-confidence value for the theoretical value of the self-confidence value (S250).

Details regarding this processing are described. First, the chi-square test value is defined by the following Expression (7).

[Expression 7]
x²=(Xₛ−E[Xₛ])²/E[Xₛ]+(X_{F}−E[X_{F}])²/E[X_{F]} (7)

Here, Xs denotes the number of successful trials among the n times of trials, and E[Xs] denotes an expected value of the number of successful trials. Moreover, X_{F} denotes the number of failure trials among the n times of trials, and E[X_{F}] denotes an expected value of the number of failure trials. Details of the chi-square test value are demonstrated in Non-Patent Document 4, and accordingly, description thereof is omitted.

Based on this definition, the case where the self-confidence value calculated by the confidence value calculation unit 320 is A1SCONF is first described. The evaluation value calculation unit 340 calculates, as Xs, the total number of elements commonly included in both of the neighbor element set (except the relevant member element) of each member element (except the reference element) of the cluster and the set of the member elements of the cluster. For example, this total number of elements is calculated by the following Expression (8). In a similar way, the evaluation value calculation unit 340 calculates, as X_{F}, the total number of elements which are not included in at least one of the neighbor element set for each member element of the cluster and the set of the member elements of the cluster. For example, this total number of elements is calculated by Expression (9).

$$[ Expression 8 ]$$

$$\begin{matrix}\begin{matrix}{X}_{s} = {\sum }_{v ∈ NN ( R , q , k ) - \{ q \}} \vert NN ( R , q , k ) ⋂ NN ( R , v , k ) - \{ v \} \vert \\ = {k}^{2} A 1 SCONF ( NN ( R , q , k ) ) - 2 k + 1\end{matrix} & ( 8 ) \\ [ Expression 9 ] & \\ {X}_{F} = {( k - 1 )}^{2} - {X}_{S} & ( 9 )\end{matrix}$$

Then, in this case, the theoretical value calculation unit 330 calculates, as the theoretical value of the self-confidence value, the expected value E[Xs] of Xs when it is assumed that NN(R, v, k) is randomly selected from R−{v}. Specifically, the expected value E[Xs] is calculated by the following Expression (10).

$$[ Expression 10 ]$$

$$E [ \vert NN ( R , q , k ) ⋂ ( NN ( R , v , k ) - \{ v \} ) \vert ] = {( k - 1 )}^{2} / ( \vert R \vert - 1 ) \\ \begin{matrix}E [ {X}_{S} ] = {\sum }_{v ∈ NN ( R , q , k ) - \{ q \}} E [ \vert NN ( R , q , k ) ⋂ NN ( R , v , k ) - \{ v \} \vert ] \\ = {( k - 1 )}^{3} ( \vert R \vert - 1 )\end{matrix} \qquad ( 10 )$$

In the way described above, the evaluation value calculation unit 340 calculates the chi-square test value by the following Expression (11). However, a definition in Expression (12) is used in Expression (11).

[Expression 11]
χ²=[(|R|−1)²(k−1)/(|R|−k)]*[A1SC(NN(R, q, k))−(k−1)/(|R|−k)]² (11)
A1SC(NN(R, q, k))=[k²*A1SCONF(NN(R, q, k))−2k+1]/(k−1)² (12)

Note that a limit value when R of this chi-square test value is made infinite becomes a value proportional to (R−1). Hence, it is more preferable that the evaluation value calculation unit 340 defines a value obtained by dividing this chi-square test value by (R−1), as the evaluation value. Thus, for the clusters individually selected from a plurality of populations of which values of R are different from each other, a comparison can also be made as to which of the clusters is more suitable. Next, the case where the self-confidence value calculated by the confidence value calculation unit 320 is AASCONF is described. For all the combinations of two member elements available from the cluster, the evaluation value calculation unit 340 calculates, as Xₛ, the sum of the number of elements commonly included both in the neighbor element set for one member element of each combination and in the neighbor element set for the other member element thereof. However, the case where a certain member element itself is included in the neighbor element set for the relevant member element is excluded. Specifically, Xs is calculated by the following Expression (13). In a similar way, for each of the above-described combinations, the evaluation value calculation unit 340 calculates, as X_{F}, the total number of member elements which are not included in at least one of the neighbor element set for one member element and the neighbor element set for the other member element. For example, X_{F} is calculated by Expression (14).

$$[ Expression 13 ]$$

$$\begin{matrix}\begin{matrix}{X}_{s} = {\sum }_{v , w ∈ NN ( R , q , k ) , v \neq w} \vert NN ( R , v , k ) ⋂ NN ( R , w , k ) \vert \\ = [ {k}^{2} ( k - 1 ) / 2 ] AASCONF ( NN ( R , q , k ) )\end{matrix} & ( 13 ) \\ [ Expression 14 ] & \\ {X}_{F} = [ {k}^{2} ( k - 1 ) / 2 ] - {X}_{S} & ( 14 )\end{matrix}$$

Then, in this case, the theoretical value calculation unit 330 calculates, as the theoretical value of the self-confidence value, the expected value E[Xs] when it is assumed that NN(R, v, k) is randomly selected from R−{v}. Specifically, the expected value E[Xs] is calculated by the following Expression (15).

$$[ Expression 15 ]$$

$$E [ \vert NN ( R , v , k ) ] NN ( R , w , k ) \vert ] = k 2 / \vert R \vert , \\ \begin{matrix}E [ {X}_{S} ] = {\sum }_{v , w ∈ NN ( R , q , k ) , v \neq w} E [ \vert NN ( R , v , k ) ⋂ NN ( R , w , k ) - \{ v \} \vert ] \\ = {K}^{3} ( k - 1 ) \vert R \vert\end{matrix} \qquad ( 15 )$$

In the way described above, the evaluation value calculation unit 340 calculates the chi-square test value by the following Expression (16).

[Expression 16]
χ²=[|R|²/(|R|−k)]*[k(k−1)/2]*[AASCONF(NN(R, q, k))−(k/|R|)]² (16)

Note that a limit value when R of this chi-square test value is made infinite becomes a value proportional to R. Hence, it is more preferable that the evaluation value calculation unit 340 defines a value obtained by further dividing this chi-square test value by R, as the evaluation value. Thus, for the clusters individually selected from the plurality of populations of which values of R are different from each other, the comparison can also be made as to which of the clusters is more suitable.

The evaluation system 30 repeats the above-described processing for each of the reference number k of elements (S260). Subsequently, the element cluster formation unit 40 obtains a reference number which maximizes the calculated chi-square test value (S270). Then, the element cluster formation unit 40 determines that the reference number of clusters maximizing the chi-square test value are the optimum clusters to be formed with the reference element taken as a center, and outputs the clusters thus determined, as a clustering result.

As above, as shown in this view, the cluster formation device 20 can calculate the self-confidence value which is the degree of confidence in selection of the cluster based on the strength in which the respective member elements correlate with each other. Moreover, the cluster formation device 20 can calculate this self-confidence value based on the calculation amount in proportion to the square of the number of member elements. Furthermore, the cluster formation device 20 determines the clusters maximizing the chi-square test value as the clusters to be formed. Thus, precision in determining the cluster can be enhanced.

### Embodiment 2

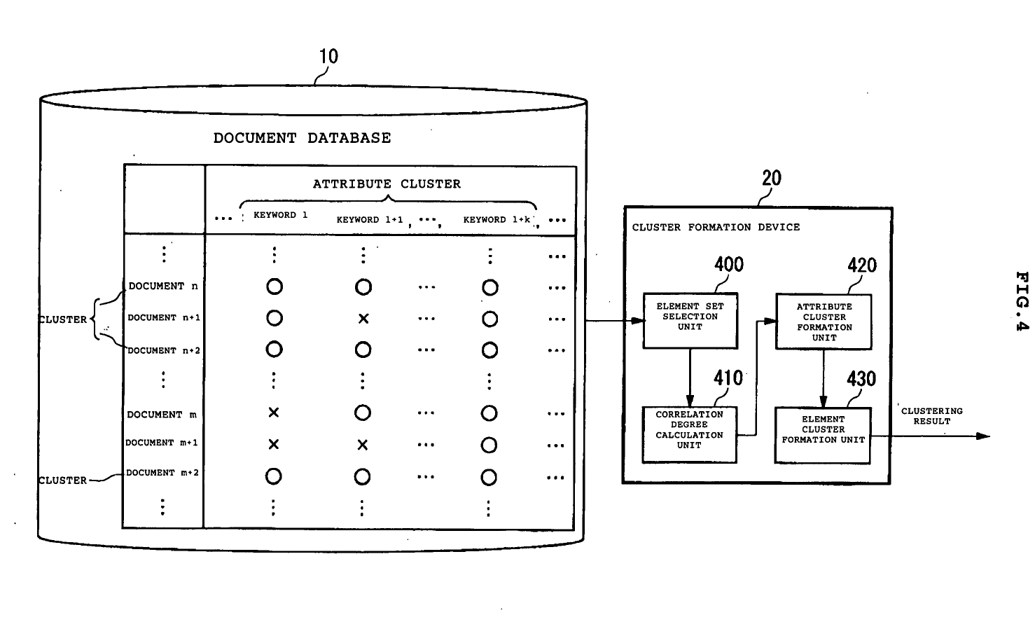

FIG. 4 is a functional block diagram of a document database 10 and a cluster formation device 20 (in Embodiment 2). An object of the cluster formation device 20 in this example is to select a set of approximately two elements having a high correlation with each other or a set of elements having an extremely low correlation with all the other elements, from a plurality of elements each having at least one of a plurality of attributes. The document database 10 stores a plurality of documents as a plurality of elements having a predetermined degree of strength of correlation with each other. Each of the plurality of documents has any of a plurality of predetermined attributes, for example, any of a plurality of keywords. As an example, a document n includes a keyword 1, keyword 1+1 . . . , and a keyword 1+k.

The cluster formation device 20 includes an element set selection unit 400, a correlation degree calculation unit 410, an attribute cluster formation unit 420, and an element cluster formation unit 430. The element set selection unit 400 selects, for each of the plurality of attributes, a set of elements having the attribute. For example, the element set selection unit 400 selects a document n, a document n+1, a document n+2, and a document m+2 as a set of documents including the keyword 1.

Then, the correlation degree calculation unit 410 calculates a degree of correlation indicating a degree of strength in which each of the plurality of attributes correlates with each of the other attributes, based on the number of elements which commonly include both of the relevant attribute and the other relevant attribute. For example, the correlation degree calculation unit 410 calculates a degree of correlation in which the keyword 1 and the keyword 1+k correlate with each other, based on the number of documents commonly including these keywords, that is, based on four of the documents n to (n+2) and the document m+2. For example, in the case where the number of documents commonly including the keywords is large, the correlation degree calculation unit 410 may calculate a higher degree of correlation than that in the case where the number is small.

Furthermore, when the degree of strength of correlation in which the plurality of elements in the document database 10 correlate with each other is determined not by the Boolean model but by the TF-IDF technology, any of the following methods may be used.
1. The correlation degree calculation unit 410 arranges values determined by the TF-IDF technology in a matrix, in which the plurality of elements are arrayed in rows and the plurality of attributes are arrayed in columns, and directly uses these arranged values as element vectors for the respective attributes.
2. The correlation degree calculation unit 410 arranges the values determined by the TF-IDF technology in the matrix, in which the plurality of elements are arrayed in the rows and the plurality of attributes are arrayed in the columns, and changes these arranged values based on the elements having the respective attributes.

In this case, the correlation degree calculation unit 410 calculates the degree of correlation between the attributes based on the element vectors. For example, the correlation degree calculation unit 410 calculates a higher degree of correlation when an angle between the element vectors is small.

The attribute cluster formation unit 420 forms an attribute cluster having a plurality of attributes of which degree of mutual correlation is equal to or more than a reference based on the calculated degree of correlation. For example, in this example, the attribute cluster formation unit 420 selects the keyword 1 to keyword 1+k, and forms the attribute cluster. In a specific example of the processing, the attribute cluster formation unit 420 may apply the existing method for forming a cluster of elements to the cluster of the attributes.

Then, the element cluster formation unit 430 obtains a set of elements having all the attributes included in the attribute cluster, and outputs the obtained set as a clustering result. For example, the document n, the document n+2 and the document m+2 are outputted. In place of this, the element cluster formation unit 430 may obtain a set of elements having any of the attributes included in the attribute cluster, and may output the obtained set as the clustering result.

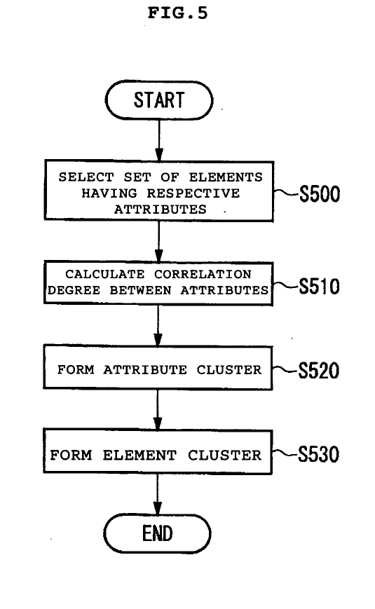

FIG. 5 shows a flow of processing where the cluster formation device 20 selects the member elements and forms the cluster (in Embodiment 2). The element set selection unit 400 selects the set of the element having the relevant attribute for each of the plurality of attributes (S500). Then, the correlation degree calculation unit 410 calculates the degree of correlation indicating the degree of strength in which each of the plurality of attributes correlates with each of the other attributes, based on the number of elements commonly including both of the relevant attribute and the other relevant attributes (S510).

Next, the attribute cluster formation unit 420 forms the attribute cluster having the plurality of attributes of which degree of mutual correlation is equal to or more than the reference, based on the calculated degree of correlation (S520). Then, the element cluster formation unit 430 obtains the set of the elements having all the attributes included in the attribute cluster, and outputs the obtained set as the element cluster (S530).

As above, according to this embodiment, the cluster formation device 20 exchanges roles of the attributes and the elements, and selects the set of a predetermined number, approximately 25, of the attributes as the attribute cluster. Then, the cluster formation device 20 selects the elements including these attributes as the cluster. Consequently, by use of the method for selecting the predetermined number, approximately 25, of elements, the elements of which number is smaller than the predetermined number can be selected as the cluster. Thus, an extremely small cluster which is difficult to be discovered by a user based on his/her experience and knowledge can be appropriately detected.

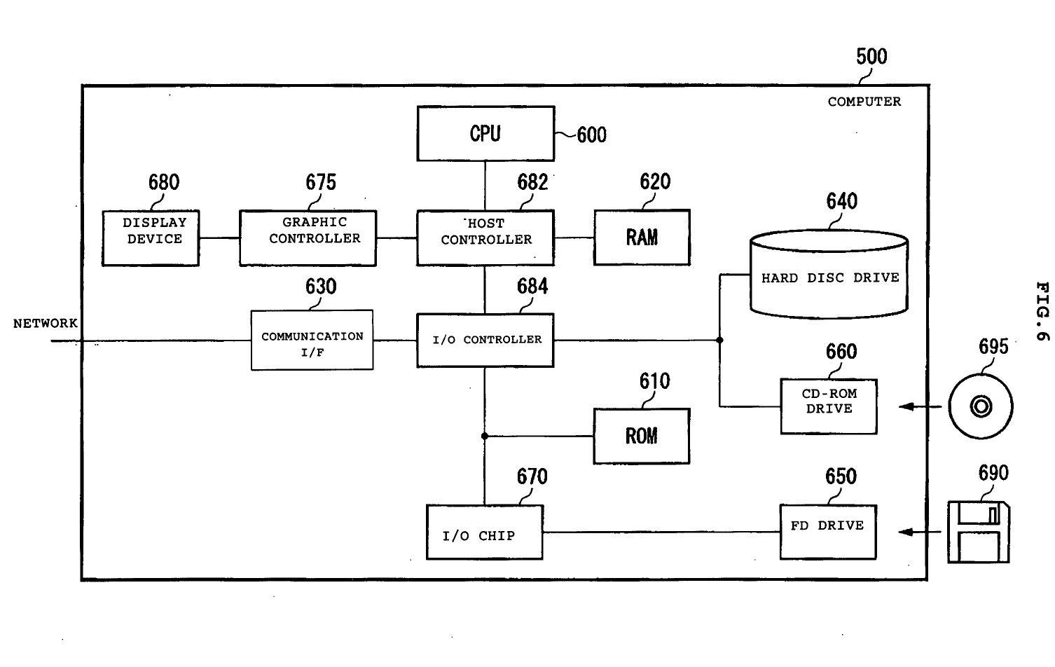

FIG. 6 shows an example of a hardware configuration of a computer 500 which functions as the cluster formation device 20 (in Embodiments 1 and 2). The computer 500 includes: a CPU and its peripheral unit, which include a CPU 600, a RAM 620, a graphic controller 675, and a display device 680, which are interconnected by a host controller 682; an input/output unit which includes a communication interface 630, a hard disk drive 640, and a CD-ROM drive 660, which are connected to the host controller 682 by an input/output controller 684; and a legacy input/output unit which includes a BIOS 610, a flexible disk drive 650, and an input/output chip 670, which are connected to the input/output controller 684.

The host controller 682 interconnects the RAM 620, and the CPU 600 and the graphic controller 675 which access the RAM 620 at a high transfer rate. The CPU 600 operates based on programs stored in the BIOS 610 and the RAM 620, and controls the respective units. The graphic controller 675 acquires image data formed on a frame buffer which the CPU 600 and the like provide in the RAM 620, and displays an image thus required on the display device 680. In place of this, the graphic controller 675 may include the frame buffer which stores the image data formed by the CPU 600 and the like in the inside thereof.

The input/output controller 684 interconnects the host controller 682, and the communication interface 630, the hard disk drive 640 and the CD-ROM drive 660 which are relatively high-speed input/output devices. The communication interface 630 communicates with an external device through a network. The hard disk drive 640 stores the program and data which the computer 500 uses. The CD-ROM drive 660 reads the program or data from a CD-ROM 695, and provides the program or data thus read to the input/output chip 670 through the RAM 620.

Moreover, relatively low-speed input/output devices such as the BIOS 610, the flexible disk drive 650 and the input/output chip 670 are connected to the input/output controller 684. The BIOS 610 stores a boot program executed by the CPU 600 at the time of activation of the computer 500, programs depending on hardware of the computer 500, and the like. The flexible disk drive 650 reads a program or data from the flexible disk 690, and provides the program or data thus read to the input/output chip 670 through the RAM 620. The input/output chip 670 connects the flexible disk 690 and a variety of input/output devices to the computer 500 through, for example, a parallel port, a serial port, a keyboard port, a mouse port and the like.

The program provided to the computer 500 is stored in a recording medium such as the flexible disk 690, the CD-ROM 695 and an IC card, and provided by a user. The program is read out from the recording medium through the input/output chip 670 and/or the input/output controller 684, installed in the computer 500, and executed there. Operations which the formation program installed in the computer 500 and executed there causes the computer 500 to perform are the same as the operations in the computer 500 described with reference to FIGS. 1 to 5, and accordingly, description thereof is omitted.

The program described above may be stored in an external recording medium. An optical recording medium such as a DVD and a PD, a magneto-optical recording medium such as an MD, a tape medium, a semiconductor memory such as an IC card, and the like, can be used as such a recording medium besides the flexible disk 690 and the CD-ROM 695. Moreover, a storage device such as a hard disk and a RAM which are provided in a server system connected to a private communication network and Internet may be used as the recording medium, and the program may be provide to the computer 500 through the network.

As above, the present invention has been described by use of the embodiments, and however, the technical scope of the present invention is not limited to the scope described in the above-described embodiments. It is obvious for those skilled in the art that a variety of alterations or modifications can be added to the above-described embodiments. It is obvious from the description of the scope of claims that an aspect added with such alterations or modifications can also be incorporated in the technical scope of the present invention.

According to the embodiments described above, evaluation systems, cluster formation devices, programs, a recording medium, evaluation methods, and a cluster formation method, which are described in the following respective items, are realized.
(Item 1) An evaluation system for calculating a self-confidence value for a cluster formed by selecting some of a plurality of elements having a predetermined degree of correlation with each other, the self-confidence value indicating a degree of confidence in selection of member elements included in the cluster, the evaluation system comprising: an evaluation target cluster selection unit which, for a predetermined reference element, selects a neighbor element set as a target cluster for evaluation, the neighbor element set being a set of a reference number of elements each having a higher correlation with the reference element; a neighbor element set selection unit which selects a neighbor element set for each of member elements included in the cluster, the neighbor element set being a set of the reference number of elements each having a higher correlation with the relevant member element; and a confidence value calculation unit which, for a combination of two member elements available from the cluster, calculates a ratio of the number of elements to the reference number, the elements being included both in the neighbor element set for one member element of the combination and in the neighbor element set for the other member element, and which outputs a value based on a sum of the ratios calculated for all the combinations of the member elements, as the self-confidence value.
(Item 2) The evaluation system according to Item 1, wherein the confidence value calculation unit defines, as a relay element, any of the reference number of elements each having the higher correlation with the reference element, calculates, for each of the reference number of elements each having the higher correlation with the relay element, the number of all the relay elements available in order to reach the relevant element, calculates a total number of combinations of two relay elements among all the relay elements available in order to reach the relevant element, and outputs, as the self-confidence value, a value based on a sum of the total numbers of the combinations, each of which is calculated for each element.
(Item 3) A cluster formation device for forming a cluster by selecting some of a plurality of elements having a predetermined degree of correlation with each other, comprising: an evaluation target cluster selection unit which, for a predetermined reference element, selects a neighbor element set as a target cluster for evaluation, the neighbor element set being a set of a reference number of elements each having a higher correlation with the reference element; a neighbor element set selection unit which selects a neighbor element set for each of member elements included in the cluster, the neighbor element set being a set of the reference number of elements each having a higher correlation with the relevant member element; a confidence value calculation unit which, for each combination of two member elements available from the cluster, calculates a ratio of the number of elements to the reference number, the elements being included both in the neighbor element set for one member element of the combination and in the neighbor element set for the other member element, and which outputs a value based on a sum of the ratios calculated for all the combinations of the member elements, as the self-confidence value; and an element cluster formation unit which determines that the target cluster for evaluation is a cluster to be formed when the self-confidence value is larger than a predetermined reference value.
(Item 4) The cluster formation device according to Item 3, wherein the cluster formation device is a device which defines a plurality of documents as the plurality of elements, and forms the cluster based on keywords included in the documents, the evaluation target cluster selection unit selects, for a predetermined document, a neighbor element set being a set of the reference number of documents including a set of keywords more similar to a set of keywords of the relevant document, as the target cluster for evaluation, the neighbor element set selection unit selects, for each of the documents included in the cluster, a neighbor element set being a set of the reference number of elements including a set of keywords more similar to a set of keywords of the relevant document, the confidence value calculation unit calculates, for a combination of two documents available from the cluster, a ratio of the number of documents to the reference number, the documents being included both in the neighbor element set for one document of the combination and in the neighbor element set for the other document, and outputs a value based on a sum of the ratios calculated for all the combinations of the documents, as the self-confidence value, and the element cluster formation unit determines that the target cluster for evaluation is the cluster to be formed when the self-confidence value is larger than the predetermined reference value.
(Item 5) An evaluation system for calculating an evaluation value of particularity of a cluster in comparison with all of a plurality of elements, for the cluster formed by selecting a predetermined reference number of elements among the plurality of elements having a predetermined degree of correlation with each other, the evaluation system comprising: an evaluation target cluster selection unit which selects a neighbor element set as a target cluster for evaluation, the neighbor element set being a set of the reference number of elements each having a higher correlation with a predetermined reference element; a neighbor element set selection unit which selects a neighbor element set for each of member elements included in the cluster, the neighbor element set being a set of the reference number of elements each having a higher correlation with the relevant member element; a confidence value calculation unit which, based on the neighbor element set selected by the neighbor element set selection unit, calculates a self-confidence value indicating a degree of confidence in selection of member elements included in the cluster; a theoretical value calculation unit which calculates a theoretical value of a self-confidence value to be calculated by the confidence value calculation unit when it is assumed that the neighbor element set selection unit randomly selects a set of the reference number of elements among the plurality of elements, instead of the neighbor element set; and an evaluation value calculation unit which calculates and outputs a chi-square test value of a self-confidence value for the theoretical value of the self-confidence value, as the evaluation value.
(Item 6) The evaluation system according to Item 5, wherein the confidence value calculation unit calculates, for each of the plurality of member elements, a ratio of elements included in the neighbor element set for the relevant member element among the elements included in the cluster, and outputs a value based on a sum of the ratios calculated for each of the member elements, as the self-confidence value.
(Item 7) The evaluation system according to Item 5, wherein the confidence value calculation unit calculates, for each combination of two member elements available from the cluster, a ratio of the number of elements to the reference number, the elements being included in both in the neighbor element set for one member element of the combination and in the neighbor element set for the other member element, and outputs a value based on a sum of the ratios calculated for all the combinations of the member elements, as the self-confidence value.
(Item 8) A cluster formation device for forming a cluster by selecting some of a plurality of elements having a predetermined degree of correlation with each other, comprising: an evaluation target cluster selection unit which selects a neighbor element set as a target cluster for evaluation, the neighbor element set being a set of a reference number of elements each having a higher correlation with a predetermined reference element; a neighbor element set selection unit which selects a neighbor element set for each of member elements included in the cluster, the neighbor element set being a set of the reference number of elements each having a higher correlation with the relevant member element; a confidence value calculation unit which, based on the neighbor element set selected by the neighbor element set selection unit, calculates a self-confidence value indicating a degree of confidence in selection of member elements included in the cluster; a theoretical value calculation unit which calculates a theoretical value of a self-confidence value to be calculated by the confidence value calculation unit when it is assumed that the neighbor element set selection unit randomly selects a set of the reference number of elements among the plurality of elements, instead of the neighbor element set; an evaluation value calculation unit which calculates and outputs a chi-square test value of a self-confidence value for the theoretical value of the self-confidence value, as the evaluation value; and an element cluster formation unit for forming a cluster by allowing the evaluation value calculation unit to calculate the evaluation value for each of clusters varying in the reference number of elements within a predetermined range, and by selecting a cluster of which the calculated evaluation value is the largest.
(Item 9) A cluster formation device for forming a cluster from a plurality of elements each having at least one of a plurality of attributes, comprising: an element set selection unit which selects a set of elements having an attribute in question, for each of the plurality of attributes; a correlation degree calculation unit which calculates a correlation degree, indicating a degree of correlation of each of the plurality of attributes with each of the other attributes, based on the number of elements having both an attribute in question and another attribute in question; an attribute cluster formation unit which forms an attribute cluster having a plurality of attributes between which the correlation degree is equal to or more than a reference, based on the calculated correlation degree; and an element cluster formation unit which determines a set of elements having at least one of the attributes included in the attribute cluster and which outputs the determined set of elements as the cluster.
(Item 10) A program for causing a computer to function as an evaluation system for calculating a self-confidence value for a cluster formed by selecting some of a plurality of elements having a predetermined degree of correlation with each other, the self-confidence value indicating a degree of confidence in selection of member elements included in the cluster, the program causing the computer to function as: an evaluation target cluster selection unit which, for a predetermined reference element, selects a neighbor element set as a target cluster for evaluation, the neighbor element set being a set of a reference number of elements each having a higher correlation with the reference element; a neighbor element set selection unit which selects a neighbor element set for each of member elements included in the cluster, the neighbor element set being a set of the reference number of elements each having a higher correlation with the relevant member element; and a confidence value calculation unit which, for a combination of two member elements available from the cluster, calculates a ratio of the number of elements to the reference number, the elements being included both in the neighbor element set for one member element of the combination and in the neighbor element set for the other member element, and which outputs a value based on a sum of the ratios calculated for all the combinations of the member elements, as the self-confidence value.
(Item 11) A program for causing a computer to function as an evaluation system for calculating an evaluation value of particularity of a cluster in comparison with all of a plurality of elements, for the cluster formed by selecting a predetermined reference number of elements among the plurality of elements having a predetermined degree of correlation with each other, the program causing the computer to function as: an evaluation target cluster selection unit which selects a neighbor element set as a target cluster for evaluation, the neighbor element set being a set of the reference number of elements each having a higher correlation with a predetermined reference element; a neighbor element set selection unit which selects a neighbor element set for each of member elements included in the cluster, the neighbor element set being a set of the predetermined number of elements each having a higher correlation with the relevant member element; a confidence value calculation unit which, based on the neighbor element set selected by the neighbor element set selection unit, calculates a self-confidence value indicating a degree of confidence in selection of member elements included in the cluster; a theoretical value calculation unit which calculates a theoretical value of a self-confidence value to be calculated by the confidence value calculation unit when it is assumed that the neighbor element set selection unit randomly selects a set of the reference number of elements among the plurality of elements, instead of the neighbor element set; and an evaluation value calculation unit which calculates and outputs a chi-square test value of a self-confidence value for the theoretical value of the self-confidence value, as the evaluation value.
(Item 12) A program for causing a computer to function as a cluster formation device for forming a cluster from a plurality of elements each having at least one of a plurality of attributes, the program causing the computer to function as: an element set selection unit which selects a set of elements having an attribute in question, for each of the plurality of attributes; a correlation degree calculation unit which calculates a correlation degree, indicating a degree of correlation of each of the plurality of attributes with each of the other attributes, based on the number of elements having both an attribute in question and another attribute in question; an attribute cluster formation unit which forms an attribute cluster having a plurality of attributes between which the correlation degree is equal to or more than a reference, based on the calculated correlation degree; and an element cluster formation unit which determines a set of elements having at least one of the attributes included in the attribute cluster and which outputs the determined set of elements as the cluster.
(Item 13) A recording medium storing the program according to any one of Items 10 to 12.
(Item 14) An evaluation method for, by using a computer, calculating a self-confidence value for a cluster formed by selecting some of a plurality of elements having a predetermined degree of correlation with each other, the self-confidence value indicating a degree of confidence in selection of member elements included in the cluster, the method comprising: by the computer, an evaluation target cluster selection step of, for a predetermined reference element, selecting a neighbor element set as a target cluster for evaluation, the neighbor element set being a set of a reference number of elements each having a higher correlation with the reference element; a neighbor element set selection step of selecting a neighbor element set for each of member elements included in the cluster, the neighbor element set being a set of the reference number of elements each having a higher correlation with the relevant member element; and a confidence value calculation step of, for a combination of two member elements available from the cluster, calculating a ratio of the number of elements to the reference number, the elements being included both in the neighbor element set for one member element of the combination and in the neighbor element set for the other member element, and outputting a value based on a sum of the ratios calculated for all the combinations of the member elements, as the self-confidence value.
(Item 15) An evaluation method for, by a computer, calculating an evaluation value of particularity of a cluster in comparison with all of a plurality of elements, for the cluster formed by selecting a predetermined reference number of elements among the plurality of elements having a predetermined degree of correlation with each other, the method comprising: by the computer, an evaluation target cluster selection step of selecting a neighbor element set as a target cluster for evaluation, the neighbor element set being a set of the reference number of elements each having a higher correlation with a predetermined reference element; a neighbor element set selection step of selecting a neighbor element set for each of member elements included in the cluster, the neighbor element set being a set of the reference number of elements each having a higher correlation with the relevant member element; a confidence value calculation step of, based on the neighbor element set selected by the neighbor element set selection unit, calculating a self-confidence value indicating a degree of confidence in selection of member elements included in the cluster; a theoretical value calculation step of calculating a theoretical value of a self-confidence value to be calculated by the confidence value calculation unit when it is assumed that the neighbor element set selection unit randomly selects a set of the reference number of elements among the plurality of elements, instead of the neighbor element set; and an evaluation value calculation step of calculating and outputting a chi-square test value of a self-confidence value for the theoretical value of the self-confidence value, as the evaluation value.
(Item 16) A cluster formation method for, by using a computer, forming a cluster from a plurality of elements each having at least one of a plurality of attributes, the method comprising: by the computer, an element set selection step of selecting a set of elements having an attribute in question, for each of the plurality of attributes; a correlation degree calculation step of calculating a correlation degree, indicating a degree of correlation of each of the plurality of attributes with each of the other attributes, based on the number of elements having both an attribute in question and another attribute in question; an attribute cluster formation step of forming an attribute cluster having a plurality of attributes between which the correlation degree is equal to or more than a reference, based on the calculated correlation degree; and an element cluster formation step of determining a set of elements having at least one of the attributes included in the attribute cluster, and outputting the determined set of elements as the cluster.

Although the preferred embodiments of the present invention have been described in detail, it should be understood that various changes, substitutions and alternations can be made therein without departing from spirit and scope of the inventions as defined by the appended claims. Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. An evaluation system comprising:
an evaluation target cluster selection unit, wherein said system is for calculating a self-confidence value for a cluster formed by selecting some of a plurality of elements having a predetermined degree of correlation with each other, the self-confidence value indicating a degree of confidence in selection of member elements included in the cluster, said evaluation target cluster selection unit to select a neighbor element set as a target cluster for evaluation, the neighbor element set being a set of a reference number of elements each having a higher correlation with a predetermined reference element;
a neighbor element set selection unit to select a neighbor element set for each of member elements included in the cluster, the neighbor element set being a set of the reference number of elements each having a higher correlation with the relevant member element; and
a confidence value calculation unit to calculate a ratio of the number of elements to the reference number, the elements being included both in the neighbor element set for one member element of a combination of two member elements available from the cluster and in the neighbor element set for the other member element, and which outputs a value based on a sum of the ratios calculated for all the combinations of the member elements, as the self-confidence value.

2. The evaluation system according to claim 1,
wherein the confidence value calculation unit defines, as a relay element, any of the reference number of elements each having the higher correlation with the reference element, calculates, for each of the reference number of elements each having the higher correlation with the relay element, the number of all the relay elements available in order to reach the relevant element, calculates a total number of combinations of two relay elements among all the relay elements available in order to reach the relevant element, and outputs, as the self-confidence value, a value based on a sum of the total numbers of the combinations, each of which is calculated for each element.

3. A cluster formation device for forming a cluster by selecting some of a plurality of elements having a predetermined degree of correlation with each other, comprising:
an evaluation target cluster selection unit which selects a neighbor element set as a target cluster for evaluation, the neighbor element set being a set of a reference number of elements each having a higher correlation with a predetermined reference element;
a neighbor element set selection unit which selects a neighbor element set for each of member elements included in the cluster, the neighbor element set being a set of the reference number of elements each having a higher correlation with the relevant member element;
a confidence value calculation unit which calculates a ratio of the number of elements to the reference number, the elements being included both in the neighbor element set for one member element of each combination of two member elements available from the cluster and in the neighbor element set for the other member element, and which outputs a value based on a sum of the ratios calculated for all the combinations of the member elements, as the self-confidence value; and
an element cluster formation unit which determines that the target cluster for evaluation is a cluster to be formed when the self-confidence value is larger than a predetermined reference value.

4. The cluster formation device according to claim 3,
wherein the cluster formation device is a device which defines a plurality of documents as the plurality of elements, and forms the cluster based on keywords included in the documents,
the evaluation target cluster selection unit selects a neighbor element set being a set of the reference number of documents including a set of keywords more similar to a set of keywords of the relevant document in comparison with a predetermined document, as the target cluster for evaluation,
the neighbor element set selection unit selects a neighbor element set being a set of the reference number of elements including a set of keywords more similar to a set of keywords of the relevant document in comparison with each of the documents included in the cluster,
the confidence value calculation unit calculates a ratio of the number of documents to the reference number, the documents being included both in the neighbor element set for one document of a combination of two documents available from the cluster and in the neighbor element set for the other document, and outputs a value based on a sum of the ratios calculated for all the combinations of the documents, as the self-confidence value, and
the element cluster formation unit determines that the target cluster for evaluation is the cluster to be formed when the self-confidence value is larger than the predetermined reference value.

5. An evaluation system for calculating an evaluation value of particularity of a cluster in comparison with all of a plurality of elements, for the cluster formed by selecting a predetermined reference number of elements among the plurality of elements having a predetermined degree of correlation with each other, the evaluation system comprising:
an evaluation target cluster selection unit which selects a neighbor element set as a target cluster for evaluation, the neighbor element set being a set of the reference number of elements each having a higher correlation with a predetermined reference element;
a neighbor element set selection unit which selects a neighbor element set for each of member elements included in the cluster, the neighbor element set being a set of the reference number of elements each having a higher correlation with the relevant member element;
a confidence value calculation unit which, based on the neighbor element set selected by the neighbor element set selection unit, calculates a self-confidence value indicating a degree of confidence in selection of member elements included in the cluster;
a theoretical value calculation unit which calculates a theoretical value of a self-confidence value to be calculated by the confidence value calculation unit when it is assumed that the neighbor element set selection unit randomly selects a set of the reference number of elements among the plurality of elements, instead of the neighbor element set; and
an evaluation value calculation unit which calculates and outputs a chi-square test value of a self-confidence value for the theoretical value of the self-confidence value, as the evaluation value.

6. The evaluation system according to claim 5, wherein the confidence value calculation unit calculates, for each of the plurality of member elements, a ratio of elements included in the neighbor element set for the relevant member element among the elements included in the cluster, and outputs a value based on a sum of the ratios calculated for each of the member elements, as the self-confidence value.

7. The evaluation system according to claim 5,
wherein the confidence value calculation unit calculates, for each combination of two member elements available from the cluster, a ratio of the number of elements to the reference number, the elements being included in both in the neighbor element set for one member element of the combination and in the neighbor element set for the other member element, and outputs a value based on a sum of the ratios calculated for all the combinations of the member elements, as the self-confidence value.

8. A cluster formation device for forming a cluster by selecting some of a plurality of elements having a predetermined degree of correlation with each other, comprising:
an evaluation target cluster selection unit which selects a neighbor element set as a target cluster for evaluation, the neighbor element set being a set of a reference number of elements each having a higher correlation with a predetermined reference element;
a neighbor element set selection unit which selects a neighbor element set for each of member elements included in the cluster, the neighbor element set being a set of the reference number of elements each having a higher correlation with the relevant member element;
a confidence value calculation unit which, based on the neighbor element set selected by the neighbor element set selection unit, calculates a self-confidence value indicating a degree of confidence in selection of member elements included in the cluster;
a theoretical value calculation unit which calculates a theoretical value of a self-confidence value to be calculated by the confidence value calculation unit when it is assumed that the neighbor element set selection unit randomly selects a set of the reference number of elements among the plurality of elements, instead of the neighbor element set;
an evaluation value calculation unit which calculates and outputs a chi-square test value of a self-confidence value for the theoretical value of the self-confidence value, as the evaluation value; and
an element cluster formation unit for forming a cluster by allowing the evaluation value calculation unit to calculate the evaluation value for each of clusters varying in the reference number of elements within a predetermined range, and by selecting a cluster of which the calculated evaluation value is the largest.

9. A cluster formation device for forming a cluster from a plurality of elements each having at least one of a plurality of attributes, comprising:
an element set selection unit which selects a set of elements having an attribute in question, for each of the plurality of attributes;
a correlation degree calculation unit which calculates a correlation degree, indicating a degree of correlation of each of the plurality of attributes with each of the other attributes, based on the number of elements having both an attribute in question and another attribute in question;
an attribute cluster formation unit which forms an attribute cluster having a plurality of attributes between which the correlation degree is equal to or more than a reference, based on the calculated correlation degree; and
an element cluster formation unit which determines a set of elements having at least one of the attributes included in the attribute cluster and which outputs the determined set of elements as the cluster.

10. A computer program product comprising a computer usable medium having computer readable program code means embodied therein for causing a computer to function as an evaluation system, the computer readable program code means in said computer program product comprising computer readable program code means for causing a computer to effect the functions of claim 1.

11. A computer program product comprising a computer usable medium having computer readable program code means embodied therein for causing a computer to function as an evaluation system, the computer readable program code means in said computer program product comprising computer readable program code means for causing a computer to effect the functions of claim 5.

12. A computer program product comprising a computer usable medium having computer readable program code means embodied therein for causing a computer to function as a cluster formation device, the computer readable program code means in said computer program product comprising computer readable program code means for causing a computer to effect the functions of claim 3.

13. A computer program product comprising a computer usable medium having computer readable program code means embodied therein for causing a computer to function as a cluster formation device, the computer readable program code means in said computer program product comprising computer readable program code means for causing a computer to effect the functions of claim 8.

14. An evaluation method comprising:
by using a computer, calculating a self-confidence value for a cluster formed by selecting some of a plurality of elements having a predetermined degree of correlation with each other, the self-confidence value indicating a degree of confidence in selection of member elements included in the cluster, the step of calculating comprising:
by the computer,
an evaluation target cluster selection step of selecting a neighbor element set as a target cluster for evaluation, the neighbor element set being a set of a reference number of elements each having a higher correlation with a predetermined reference element;
a neighbor element set selection step of selecting a neighbor element set for each of member elements included in the cluster, the neighbor element set being a set of the reference number of elements each having a higher correlation with the relevant member element; and
a confidence value calculation step of calculating a ratio of the number of elements to the reference number, the elements being included both in the neighbor element set for one member element of a combination of two member elements available from the cluster and in the neighbor element set for the other member element, and outputting a value based on a sum of the ratios calculated for all the combinations of the member elements, as the self-confidence value.

15. An evaluation method comprising:
by a computer, calculating an evaluation value of particularity of a cluster in comparison with all of a plurality of elements, for the cluster formed by selecting a predetermined reference number of elements among the plurality of elements having a predetermined degree of correlation with each other, the step of calculating comprising:
by the computer,
an evaluation target cluster selection step of selecting a neighbor element set as a target cluster for evaluation, the neighbor element set being a set of the reference number of elements each having a higher correlation with a predetermined reference element;
a neighbor element set selection step of selecting a neighbor element set for each of member elements included in the cluster, the neighbor element set being a set of the reference number of elements each having a higher correlation with the relevant member element;
a confidence value calculation step of, based on the neighbor element set selected by the neighbor element set selection unit, calculating a self-confidence value indicating a degree of confidence in selection of member elements included in the cluster;
a theoretical value calculation step of calculating a theoretical value of a self-confidence value to be calculated by the confidence value calculation unit when it is assumed that the neighbor element set selection unit randomly selects a set of the reference number-of elements among the plurality of elements, instead of the neighbor element set; and
an evaluation value calculation step of calculating and outputting a chi-square test value of a self-confidence value for the theoretical value of the self-confidence value, as the evaluation value.

16. A cluster formation method comprising:
by using a computer, forming a cluster from a plurality of elements each having at least one of a plurality of attributes, the step of forming comprising:
by the computer,
an element set selection step of selecting a set of elements having an attribute in question, for each of the plurality of attributes;
a correlation degree calculation step of calculating a correlation degree, indicating a degree of correlation of each of the plurality of attributes with each of the other attributes, based on the number of elements having both an attribute in question and another attribute in question;
an attribute cluster formation step of forming an attribute cluster having a plurality of attributes between which the correlation degree is equal to or more than a reference, based on the calculated correlation degree; and
an element cluster formation step of determining a set of elements having at least one of the attributes included in the attribute cluster, and outputting the determined set of elements as the cluster.

17. An article of manufacture comprising a computer usable medium having computer readable program code means embodied therein for causing evaluation, the computer readable program code means in said article of manufacture comprising computer readable program code means for causing a computer to effect the steps of claim 14.

18. An article of manufacture comprising a computer usable medium having computer readable program code means embodied therein for causing evaluation, the computer readable program code means in said article of manufacture comprising computer readable program code means for causing a computer to effect the steps of claim 15.

19. An article of manufacture comprising a computer usable medium having computer readable program code means embodied therein for causing cluster formation, the computer readable program code means in said article of manufacture comprising computer readable program code means for causing a computer to effect the steps of claim 16.

20. A computer program product comprising a computer usable medium having computer readable program code means embodied therein for causing a computer to function as a cluster formation device, the computer readable program code means in said computer program product comprising computer readable program code means for causing a computer to effect the functions of claim 9.
